(19) United States
(12) Patent Application Publication
(10) Pub. No.: US 2014/0212067 A1
(43) Pub. Date: Jul. 31, 2014

(54) CONVERTIBLE STORAGE BAG AND MARINE SIGNAL FLAG

(71) Applicant: BGA INDUSTRIES LLC, DAYTONA BEACH, FL (US)

(72) Inventor: Charlie Hicks, Daytona Beach, FL (US)

(73) Assignee: BGA INDUSTRIES LLC, DAYTONA BEACH, FL (US)

(21) Appl. No.: 14/070,027

(22) Filed: Nov. 1, 2013

Related U.S. Application Data
(60) Provisional application No. 61/721,176, filed on Nov. 1, 2012.

(51) Int. Cl. A45C 9/00; G09F 17/00

(52) U.S. Cl. CPC A45C 9/00; G09F 17/00
USPC 383/4

(57) ABSTRACT

A convertible device that is transformable from a storage bag to a marine signal flag by providing water permeable open mesh body of hollow material with stitched edges and an access opening. Rods on the interior of the body are attached to diagonally opposed corners. The rods disconnect to provide a bag form. The rods connect to provide a rigid brace between the diagonally opposed corners of the interior of the material to provide a flag form. Eyelets along a stitched edge of the material are used to attach the device to a flag pole.

### PRIORITY CLAIM

This application claims priority benefit of U.S. Provisional Patent Application No. 61721176 filed on Nov. 1, 2012.

### FIELD OF THE INVENTION

This invention relates to storage bags suited for marine use. More particularly, the invention relates to a storage bag that may be converted into a marine signal flag.

### BACKGROUND OF THE INVENTION

There are numerous dive bags on the market and also many different styles and size of dive flags. However, there are no dive flag and storage bag combination products that are convertible to a flat rectangular dive flag and useful for displaying as a warning signal flag on a vessel. Laws require a dive flag to be flown at a site when divers are below the water surface. Thus, divers sometimes experience the frustration of being on a vessel when they discover a site to dive, only to realize that they have do not have a dive flag available and must cancel the desired dive.

There are about 3 million divers registered in the United States alone. It is typical for an active diver to buy at least one dive bag and one dive flag annually. Despite this preparation, it is inevitable that a diver will pack gear into a dive bag in preparation for a dive, but manage to forget the required flag. Therefore, a need exists to provide end users with the peace of mind of knowing that when they have their dive equipment packed into their dive bag, they will always have their dive flag available, even if they forget. Cancelling a dive at the last minute because of a missing dive flag can be avoided if this problem is solved.

Some elongate cylindrical dive bags have been designed with a mesh body and a solid material end having the diver down warning flag depicted on the end. However, this bag does not function well as a flag. The elongate cylindrical bag will dangle from any attempt to hang the bag on a flag holder. Moreover, the end of the bag with the flag emblem does not provide any means for attachment to a flag pole. Thus, this type of bag design provides a very shoddy solution if a regular dive flag has been forgotten. The bags poor appearance as a warning signal would make it a dangerous and possibly illegal solution to providing a dive flag.

### SUMMARY OF THE INVENTION

The present invention provides a supply storage bag that can be used for diving gear that is easily convertible to a warning signal flag. The convertible bag can be used for any common nautical flag and can convert from a bag to a flag in seconds. A mesh material forms the body of the bag that is stitched along 3 edges and opens on a 4^{th} edge providing an open end for loading gear. Two stiffener rods are attached to diagonally separate interior corners of the bag. These rods fold neatly out of the way for the bag to readily store gear, such as diving gear. In bag is converted into a stiffened dive flag by connecting the two stiffener rods with a female end receiving an end of an opposing rod.

The body of the bag may be manufactured of marine grad materials to provide a durable product. For instance, the bag material may be a tough and water resistant nylon mesh that is durable enough to withstand the most rugged use and conditions and dries quickly after becoming wet. Also, the bag may include a nylon draw cord in the open end with a slip lock or the like to fasten the bag opening and retain gear securely.

The bag includes grommets or eyelets on at least one edge. When the bag is converted to a flag, the stiffened flag is attached on one edge having the grommets to a holding device such as a flag pole. The upper corner of the flag that opposes the edge attached to the holding device is reinforced and stiffened by the connected rods. Meanwhile, the lower corner portion opposing the attachment edge may simply hang downward for easy visibility. An additional grommet may be provided in the upper opposing corner for additional support of the top edge of the flag using a horizontal member, which may extend from a vertical member comprising the holding device.

An object of the present invention is to keep the dive experience fun by providing an alternative dive flag in the case a diver has forgotten to bring a required flag.

Another object of the invention is to provide the end user with a durable and functional dive bag.

Yet another object of the invention is to provide a flag that functions as a legal marine signal.

### BRIEF DESCRIPTION OF THE DRAWINGS

FIG. 1 is a perspective view of a device in a first form as a storage bag in accordance with a preferred embodiment of the invention used for storage of typical diving gear.

FIG. 2 is a plan view of the device in a second form as a flag in accordance with the invention and displayed as a dive flag attached onto a typical flag pole for vertical support on a marine vessel.

FIG. 3A is an interior plan view of the device laid flat and turned inside out to illustrate rigid connecting members that are disengaged in accordance with the invention.

FIG. 3B is an interior plan view of the device laid flat with the rigid interior members connected converting the bag form of the device into a stiffened flag form.

FIG. 4 is an exterior plan view of the device showing one edge of the storage bag form having grommets for connection to a vertical support when converted to a flag and another edge of the storage bag providing an access opening for insertion of items.

### DETAILED DESCRIPTION OF THE PREFERRED EMBODIMENTS

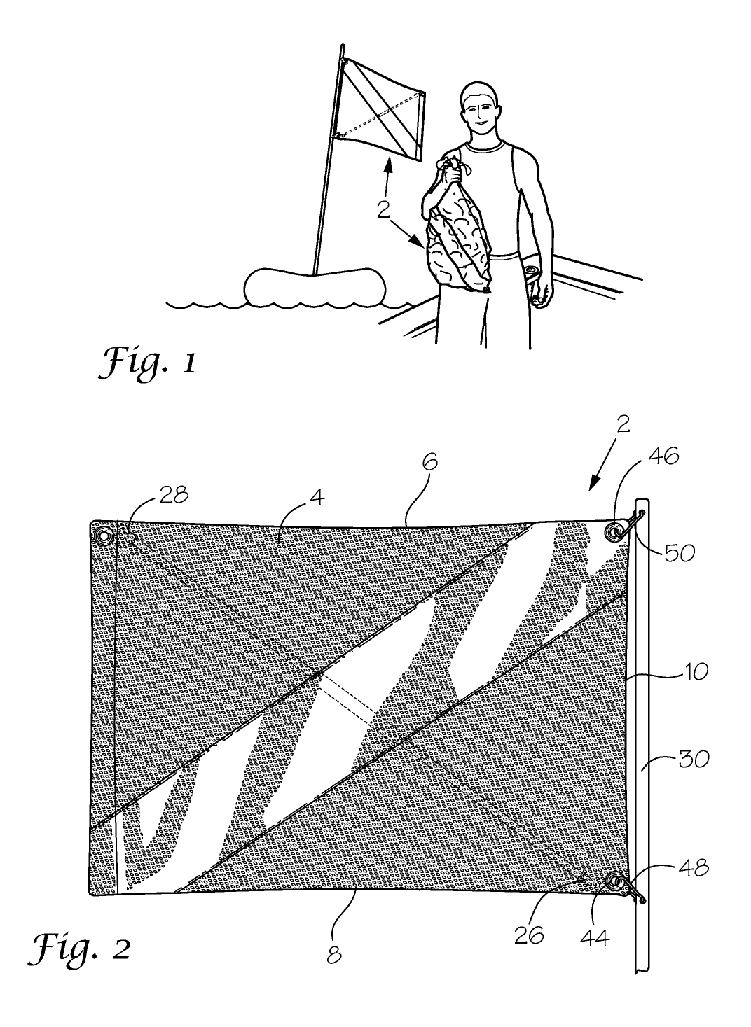

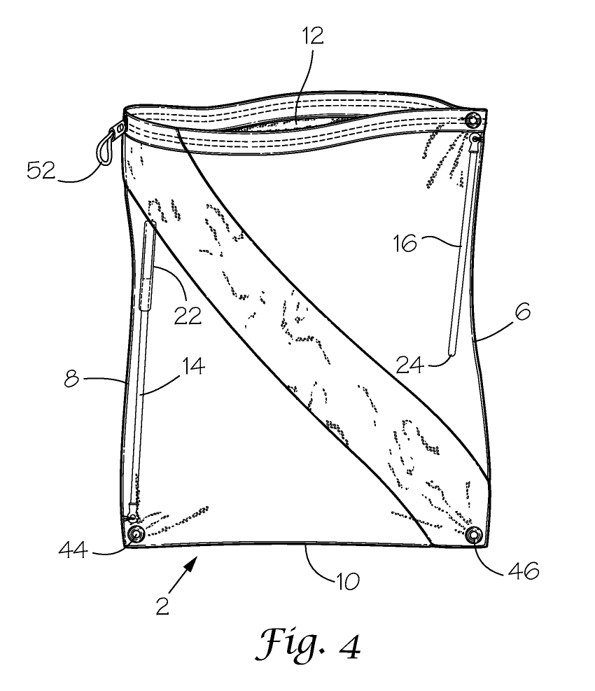

Referring to FIG. 1 a convertible device 2 in a first form as a storage bag is shown. The device is transformable into a second form as a marine signal flag also shown in the depiction of FIG. 1. The storage bag can hold gear such as typical diving gear used by a scuba diver. The embodiment shown depicts the bag comprised of a soft open overlapping body of mesh material 4, which is illustrated in FIG. 2. The material is permeable to water. Because the material is generally soft, it crumples, especially when empty. The overlapping body of material provides a hollow interior for storing supplies as shown in FIGS. 1 and 4. The hollow interior of the bag will spread apart to form an interior cavity where the supplies are stored. The body includes opposite edges thereof forming sides 6 and 8 of the bag, and opposing ends provide an edge forming a bottom 10 of the body of the bag and an opposing separable end on another edge to form an access opening 12 of the bag.

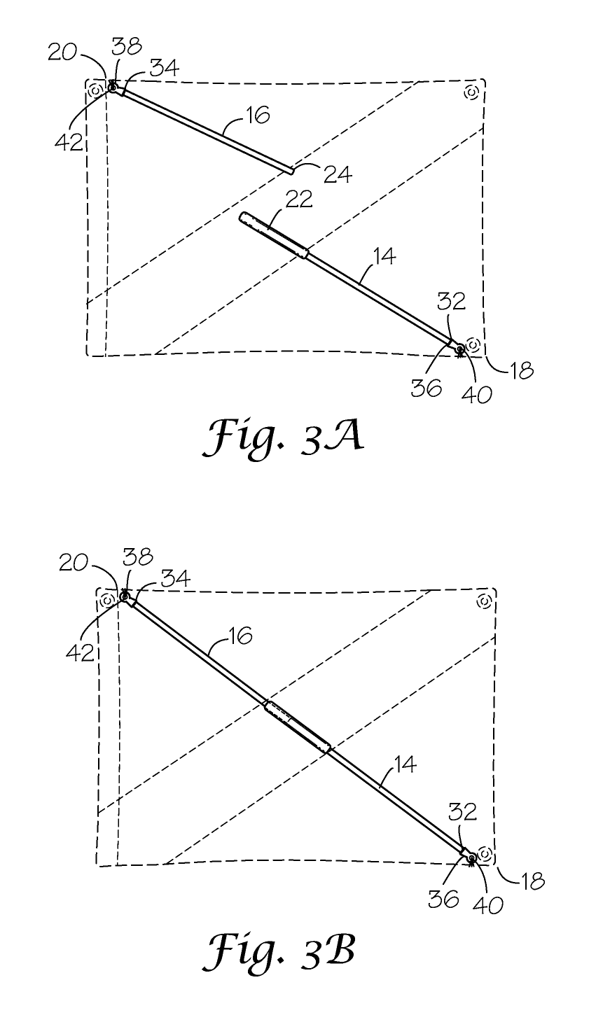

Referring to FIG. 4, a part of the hollow interior is shown at the edge forming the access opening 12. A portion of a first rigid member 14, rod A, and a second rigid member 16, rod B, can be seen in the interior portion. These rigid members are used in conversion of the device from the first form shown in FIG. 1, which is a bag, to a second form as a flag as shown in FIGS. 2 and 3B. When the device is used as a bag, the rigid members 14 and 16 are disconnected from each other as shown in FIG. 3A. These rigid members hang loose within the bag and do not inhibit use of the device as a storage bag. The preferred rigid members 14 and 16 comprise a pair of rods (A and B) attached to the diagonally opposed corners 18 and 20 of the bag.

In FIG. 3A the bag is laid flat, and the figure shows the bag from an overhead view to illustrate the general shape of the bag when empty and stretched out on a flat surface. As seen in FIG. 3A, the device 2 is generally rectangular shaped in the embodiment shown and convertible to a marine signal flag indicating a diver down. The red flag with white diagonal stripe, while not international, is commonly used to indicate a diver in the water. Many states now require this flag. It is usually exhibited on a float to mark the diver's approximate location, whereas the “A” flag should be used on the vessel when stationary in international waters and has a diver down. Thus, it is contemplated that the bag may be shaped according to the particular signal flag that the bag will be converted to.

For instance, the blue and white Alfa international signal flag is used by ships at sea to indicate a diver below when stationary. The Alfa (“A” flag) has a rectangular shape with a triangular section that might be removed from the blue portion, creating a 5-sided design with a swallow tail. The means for securing a flag to an object is situated on the straight edge of the bag when stretched out as shown in FIG. 2.

FIG. 3B shows the bag with the rigid connector member rods being inside the bag, and the bag converted into a flag by connecting the female end 22 of rod A with the male end 24 of rod B. While mostly rigid, the rods may give and bend slightly with resilience to allow the ends to be connected and then form a tight fit, which benefits from the tension between the connected rods and the stretched material where the rods are attached to diagonally opposed corners 18 and 20. The tension causes the bag to become and stay taut along the diagonal from the lower corner of the stitched edge where the device is attached to a first attachment member 26 to the upper diagonally opposed corner and a second attachment member 28. This converts the bag into a flag for hanging on a pole 30 or other flag support. The lower distal corner from the flag pole 30 will hang straight downward when the flag is installed on a pole and does not necessarily require any reinforcement when being held as a flag. Some flag poles may include a horizontal cross-member and the flag may include a means for attaching the horizontal cross-member to the upper distal corner of the flag from the pole. The flag pole 30 provides a vertical or upright support for display on the flat on a marine vessel. Other suitable supports may be used to support the flag in upright position. The flag may also be supporting on a floating support such as an inflatable tube, shown in FIG. 1, which is separate from the marine vessel.

To convert the device 2 from a flag back into a bag, the rigid members 14 and 16 may be disconnected from each other as shown in FIG. 3A. Referring to FIG. 3A the male and female coupling ends 22 and 24 of the rods are shown more closely. As shown, the length of the rods may be overlapping so the fabric of the bag will stretch to connect the rods A and B, helping to create the taut condition of the material for conversion to a signal flag.

Any suitable means may be provided for attaching the ends of the rods to the corners of the bag. In the figures, an attachment member 26, 28 is shown including caps 32, 34 attached to the end of each rod A or B, a tab 36, 38 is attached to each cap and extends lengthwise from the respective cap, and a rivet 40, 42 is attached through a respective section of the corner of the material and through the respective tab. Whereby, the corner of the bag is permanently attached to each respective rod. Other attachment means may include a bolt with nut, adhesive means, lashing, or other suitable method.

As discussed above, the material comprising the bag is soft and crumples easily. Therefore, the device can be compacted or rolled up to a compact form. The compacted bag can be stored in a sleeve or stuffed into a small storage compartment, such as the sidewall compartment of a vessel. The bag is easy to convert from compacted form by spreading the material and opening the access opening end of the bag to insert items for storage. Or, the material is spread and one reaches within to connect the rigid members 14 and 16 to convert the device into a flag.

The flag pole attachment means includes a top support and a bottom support that may comprise a pair of metal eyelets 44, 46 arranged in the closed edge of the bag by installing grommets as shown in FIG. 4. The grommets add the needed reinforcement to the holes in the material. Whereby, when the bag device is converted to a flag, the material is attached to the flag support, such as the flag pole 30, by tying or attaching the flag to the holding member via the eyelets 44, 46 using clips 48, 50. Other alternative holding means may be arranged in combination with the bag in lieu of installing grommets. In one alternative embodiment, the closed edge of the bag may include a sleeve along the length of the edge for receiving a pole or elongate flag support, whereby the support slides into the sleeve to hold the flag.

The device may include means for closing the access opening. As shown in FIGS. 1 and 4, a draw string 52 may be inserted into the stitched edge of the access opening and provided an exposed portion for pulling the draw string. The draw string will close the bag for securing items therein. Another embodiment may include a zipper or hook and loop fastener on the edge of access opening.

1. A convertible device transformable to a storage bag or a flag, comprising: a bag having a hollow interior and an access opening, a first rigid member attached to an interior corner of the bag and a second rigid member attached to a diagonally opposed interior corner of the bag; wherein said bag comprises an overlapping body of material with opposite edges thereof forming sides of said hollow interior, said body of material having an additional edge forming a bottom of the hollow interior and having an opposing separable end to form said access opening, wherein said body of material is generally soft to crumple or uncrumple in a first form as a bag, and said rigid members are disconnected in said first form; and wherein said body of material is generally flat in a second form as a flag, and said rigid members are connected in said second form.

2. A convertible device as in claim 1 including a top support and a bottom support on the stitched edge for attachment of the device to a flag pole.

3. A convertible device as in claim 1 in which said first rigid member comprises a first rod being and said second rigid member comprises a second rod.

4. A convertible device as in claim 3 in which said first rod includes a female receptacle on one end and the second rod includes a male member for insertion into the female receptacle whereby the first rod connects to the second rod.

5. A convertible device as in claim 4 in which said first rod and said second rod have overlapping ends when disconnected and each rod is bendable and resilient for insertion of the male member into the female receptacle.

6. A convertible device as in claim 1 wherein said overlapping body of material comprises an open mesh material permeable to water.

7. A convertible device as in claim 1 in which said opposite edges forming sides are stitched and said additional edge forming a bottom of the hollow interior is stitched.

8. A convertible device as in claim 3 in which said first rod and said second rod are attached to the interior of the body of material at diagonally opposed corners.

9. A convertible device as in claim 8 including attachment members for attachment of the rods to the interior body of the material, said attachment members each comprising a cap with a tab extending from the cap and attached to the respective corner by a rivet.
